(19) United States
(12) Patent Application Publication
(10) Pub. No.: US 2007/0138341 A1
(43) Pub. Date: Jun. 21, 2007

(54) Transformable skin

(76) Inventors: Shiv P. Joshi, Rancho Palos Verdes, CA (US); David L. Cowan, Lakewood, CA (US)

Correspondence Address: c/o Gerald Andersen;Ste 400, 2780 Skypark Drive, Torrance, CA, 90505, US

(21) Appl. No.: 11/007,728

(22) Filed: Dec. 7, 2004

(51) Int. Cl. B64C 1/00

(52) U.S. Cl. 244/129.1

(57) ABSTRACT

A transformable skin. The transformable skin includes a first mechanism for enabling a first type of deformation of the skin. A second mechanism resists a second type of deformation that is different than the first type of deformation in direction or form. In a more specific embodiment, the first mechanism and the second mechanism are interconnected. The first type of deformation is strain deformation along a first path that is inline with a first axis of the skin. In the specific embodiment, the second type of deformation includes shear deformation and strain deformation that is inline with a second axis that is approximately perpendicular to the first axis. The first mechanism includes a plural partially planar spring structures arranged parallel to each other. The plural partially planar spring structures are resistant to bending and are interconnected via rigid connecting structures. The spring structures are partially planar, and the connecting structures are covered with an elastomeric material.

This invention was made with Government support under Defense Advanced Research Projects Agency (DARPA) Contract No. F33615-02-C-3257. The Government may have certain rights in this invention.

### BACKGROUND OF THE INVENTION

1. Field of Invention

This invention relates to surfacing systems and materials. Specifically, the present invention relates to geometrically transformable layers, such as flexible airfoil skins or coverings.

2. Description of the Related Art

Geometrically transformable skins are employed in various demanding applications including sunroofs, sails, and morphing wings. Such applications demand versatile coverings with specific flexibility and rigidity requirements.

Versatile transformable skins are particularly important in morphing-wing applications, where large pressure and temperature gradients, aerodynamic loads, and drastic wing shape changes are common. In such applications, tradeoffs between skin flexibility and structural support capabilities are particularly problematic. Flexible skins typically lack sufficient bending stiffness to withstand large aerodynamic loads. Skins with suitable bending stiffness often lack sufficient elasticity or flexibility to enable drastic wing shape changes. Furthermore, conventional flexible skins are often undesirably susceptible to permanent deformation.

An exemplary transformable covering is disclosed in U.S. Pat. No. 6,173,925, by Mueller, et al., entitled SKIN-RIB STRUCTURE, issued Jan. 16, 2001. The structure employs two skins with vertical ribs interconnecting the skins. Unfortunately, such skins are complex and expensive to implement and provide insufficient bending stiffness for many applications. Furthermore, the interconnections between the skins and ribs are particularly susceptible to wear.

Hence, a need exists in the art for a durable flexible skin that provides sufficient flexibility to enable large in-plane shape changes of an underlying structure while maintaining sufficient bending stiffness to provide structural support. There exists a further need for an accompanying airfoil and aircraft employing the flexible skin.

### SUMMARY OF THE INVENTION

The need in the art is addressed by the transformable skin of the present invention. In the illustrative embodiment, the inventive skin is adapted for use with transformable airfoils, such as morphing aircraft wings. The transformable skin includes a first mechanism for enabling a first type of deformation of the skin. A second mechanism resists or prevents a second type of deformation that is different than the first type of deformation in direction or form.

In a more specific first embodiment, the first mechanism and the second mechanism are interconnected. The first type of deformation is elastic strain deformation along a first path that is inline with a first axis of the skin. In this specific embodiment, the second type of deformation includes strain deformation that is inline with a second axis that is approximately perpendicular to the first axis and includes shear deformation. The first mechanism includes plural substantially planar spring structures arranged parallel to each other. The plural substantially planar spring structures resist bending in response to forces perpendicular to the plane of the spring structures. The substantially planar spring structures are interconnected via connecting structures of the second mechanism that also resist deformation in the perpendicular planar direction and therefore add to the bending stiffness of the skin. The spring structures and connecting structures are partially planar and covered with or sandwiched between elastomeric material.

In an alternative embodiment, the first type of deformation, which is enabled by the transformable skin, includes elastic shear deformation. In the alternative embodiment, the first type of deformation enabled by the transformable skin further includes elastic strain deformation in addition to the shear deformation. The elastic strain deformation is permitted up to a predetermined length beyond which strain deformation is inhibited by the second mechanism. In this embodiment, the skin includes plural parallel stiff members that implement the second mechanism. The parallel stiff members may be interconnected via or sandwiched between elastomeric material to facilitate implementing the first and second mechanisms.

The novel design of one embodiment of the present invention is facilitated by the second mechanism, which inhibits bending deformation without inhibiting strain or shear deformation. The resulting skin provides superior structural support capabilities while requiring minimal energy to implement strain and shear transformations of an accompanying airfoil.

### BRIEF DESCRIPTION OF THE DRAWINGS

FIG. 1 is a diagram showing a flexible skin enabling horizontal strain deformation while maintaining lateral dimension by maintaining bending stiffness according to an embodiment of the present invention.

FIG. 2 is a diagram of the flexible skin of FIG. 1 in a partially extended position.

FIG. 3 is a diagram juxtaposing magnified views of a first exemplary junction configuration and a second exemplary junction configuration corresponding FIGS. 1 and 2, respectively.

FIG. 4 is a magnified view of a first alternative embodiment of the flexible skin of FIG. 1.

FIG. 5 is a diagram of a second alternative embodiment of the flexible skin of FIG. 1.

FIG. 6 is a diagram of the flexible skin of FIG. 5 exhibiting shear deformation.

FIG. 7 is a more detailed diagram illustrating flexible connectors between connecting beams and the bottom horizontal beam of the flexible skin of FIG. 6.

FIG. 8 is a diagram of a third alternative embodiment of the flexible skin of FIG. 1 having unique junctions for tailoring horizontal and vertical strain deformation characteristics.

FIG. 9 is a more detailed diagram illustrating one of the unique junctions of FIG. 8.

FIG. 10 is a diagram of the flexible skin of FIG. 8 in a partially extended position.

FIG. 11 is a diagram of an exemplary morphing airfoil 70 employing the flexible skin 10 of FIG. 1.

### DESCRIPTION OF THE INVENTION

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

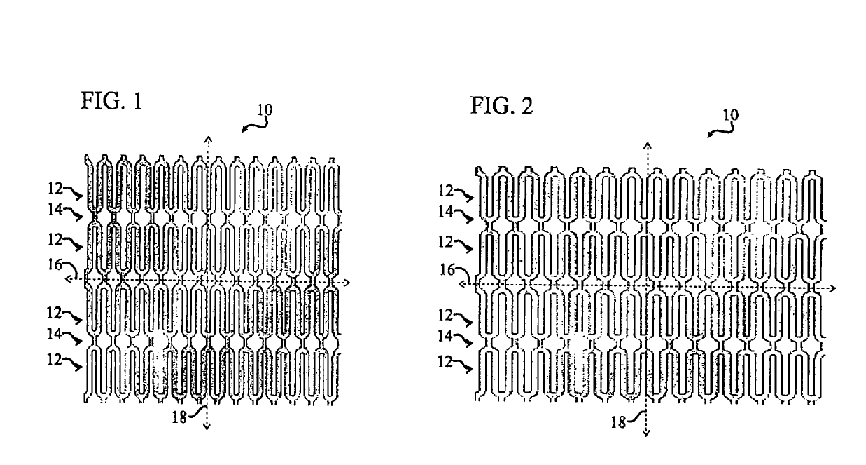

FIG. 1 is a diagram showing a flexible skin 10 that enables horizontal extension, i.e., strain deformation, while maintaining bending stiffness, i.e., inhibiting bending deformation. For clarity, certain features, such as skin mounting connectors, have been omitted from the figures. However, those skilled in the art with access to the present teachings will know which features to implement and how to implement them to meet the needs of a given application.

The flexible skin 10 includes plural coplanar partially planar springs 12. The partially planar springs 12 are interconnected and aligned with a plane of the skin 12 via partially planar vertical connecting beams 14, which are oriented approximately perpendicular to an exemplary strain axis 16 of the flexible skin 10. The strain axis 16, which is a horizontal axis in the present embodiment, is perpendicular to a vertical axis 18. The springs 12 and partially planar vertical connecting beams 14 resist bending moments, such as bending moments about the longitudinal axis 16, thereby providing in-plane rigidity, also called bending stiffness or flexural stiffness. By resisting deformation in the perpendicular planar direction (normal to the skin 10), the connecting beams 14 contribute to the overall bending stiffness of the skin 10.

For the purposes of the present discussion, in-plane rigidity is stiffness or resistance to bending or deformation into positions outside of a predetermined plane or surface. For example, a skin that exhibits in-plane rigidity resists deformation that is not in response to forces parallel to the surface area of the skin, such as deformation about any axis contained with the surface area of the skin. Furthermore, such a skin that exhibits in-plane rigidity will resist bulging or deformation that would displace the skin from the original plane of the skin.

Furthermore, for the purposes of the present discussion, a substantially flat or partially planar spring is a spring that has a trace that may be laid substantially flat over a surface such that the majority of the surface area of the trace associated with one side of the partially planar spring rests on the surface. Hence, a conventional cylindrical coiled spring is not considered substantially flat or partially planar.

Similarly, a substantially flat or partially planar beam is a beam that may be laid flat upon a surface so that the majority of the surface area of the beam associated with one side of the beam, rests upon the surface. Hence a cylindrical rod is not considered substantially flat for the purposes of the present discussion, but a beam with a square or rectangular cross-section is.

For the purposes of the present discussion, a deformable skin is a covering with an outer shape and/or surface area that may adapt to accommodate geometrical changes in a structure that supports and/or is covered by the skin. Consequently, sliding skins, and various flexible skins, such as elastomeric skins, are considered deformable skins. Furthermore, a deformable skin may be porous. The terms deformable skin and transformable skin are used interchangeably in the present discussion.

A load-bearing deformable skin is adapted to resist pressure loads normal or perpendicular to the surface. The degree to which a load-bearing skin resists loads is application-specific. A load-bearing skin resists caving-in or bulging-out in response to loads applied perpendicular to the surface of the skin. Accordingly, load-bearing skins generally transfer such pressure loads to the underlying support structure that is covered by the skin. Ideally, load-bearing deformable skins adapted for use with transformable airfoils exhibit in-plane rigidity comparable to that of conventional fixed skins, such as those covering conventional fixed-wing aircraft.

In the present specific embodiment, the flexible skin 10 is a load-bearing deformable skin. The flexible skin 10 may be further reinforced with various layers of elastomeric material as discussed more fully below. The exact choice of layering materials is application-specific and may be readily determined by one skilled in the art to meet the needs of a given application without undue experimentation.

In operation, the springs 12 and accompanying connecting rods 14 act as an interconnected spring structure that forms a skin frame. An elastomeric material, such as rubber, may be disposed over the skin 10 to reduce the porosity of the skin to meet the needs of a given application.

The springs 12 are oriented parallel to the axis 16. Accordingly, the skin 10 may stretch, exhibiting elastic strain deformation in horizontal directions or paths parallel to the axis 16. The skin 10 is resistant to stretching in directions or along paths that are not approximately parallel to the axis 16. For example, the rigid connecting beams 14 and the vertical rigidity of the springs 12 cause the skin 10 to resist extension perpendicular to the axis 16, i.e., parallel to the vertical axis 18, when the springs 12 are maximally compressed.

Furthermore, the rigid vertical connecting beams 14 selectively inhibit shear deformation. For example the skin 10 resists horizontal shear deformation in response to shearing forces that are parallel to the axis 16 when the springs 12 remain maximally compressed. When the springs 12 are extended, the skin 10 may exhibit horizontal shear deformation, since one side of the skin may compress while the other side expands or remains fixed.

Those skilled in the art will appreciate that the skin 10 resists vertical shear deformation in response to shearing forces that are approximately perpendicular to the horizontal axis 16. To enhance resistance to vertical shear deformation, the spring structures 12 are made taller and thicker with tighter-radius turns. The state of compression of the springs 12 typically has less effect on vertical shear deformation than on horizontal shear deformation.

To achieve the above-mentioned spring properties and corresponding skin properties, the skin 10 is constructed by employing lithography to etch the interconnected springs 12 and connecting beams 14 in a partially rigid metallic layer. As is known in the art, lithography may involve application of positive or negative photoresist to a metallic surface. Ultraviolet light may then be employed to selectively alter the photoresist to achieve a desired photoresist pattern. The altered or unaltered photoresist is then washed from the metallic surface, and the exposed metal is then etched via an etching agent. Subsequently, a chemical is applied to remove the remaining photoresist.

Alternatively, the pattern formed by the springs 12 and connecting beams 14 is stamped into a metal sheet. In the present specific embodiment, skin structure 10 is made from a memory material, such as nickel titanium, that can exhibit repeated plastic deformation. However, other materials, including polymers and various alloys, may be employed to construct the springs 12 and connecting beams 14 without departing from the scope of the present invention. The springs 12 are chosen to be thick enough to provide sufficient rigidity for a particular application.

The exact dimensions of the springs 12 and connecting beams 14 are application specific and may be readily determined by those skilled in the art to meet the needs of a given application. For example, in miniature Unmanned Aerial Vehicle (UAV) applications, the springs 12 may have dimensions on the order of micrometers or nanometers. In larger aircraft, the springs 12 may have dimensions on the order of inches or larger. The connecting beams 14 may be shrunk so that the springs 12 are bonded directly together. Furthermore, the radii of curvature of the springs 12 may be adjusted relative to the width of the springs 12. In addition, the traces of the springs 12 may be made thicker or thinner or may have strategically varying thickness and/or cross-sectional areas. The thickness of the springs 12 may be varied by employing an initial metallic sheet having varying thickness. Furthermore, by selectively choosing materials and dimensions, the spring properties, such as spring constants, of the springs 12 may be appropriately adjusted.

Those skilled in the art will appreciate that each of the springs 12 may have different spring constants to create certain zones in the skin 10 that are more susceptible to strain deformation than other zones. This may benefit applications wherein certain skin areas deform more than other skin areas, and wherein certain skin regions will benefit from more bending rigidity. Accordingly, the properties of the skin 10 may be strategically varied across the skin 10 by selectively adjusting spring parameters, such as dimensions and material composition.

The unique and versatile spring structure 10 selectively enables in-plane horizontal strain deformation while providing in-plane rigidity to inhibit bending, thereby providing structural support while allowing shape changes of an underlying structure, such as a transformable airfoil. The skin 10 resists certain types of in-plane deformation, such as vertical strain and shear deformation, partially due to the rigidity of the material employed to construct the skin 10.

In the present embodiment, the chosen material, nickel titanium, is sufficiently durable to enable the springs 12 to repeatedly return to their original position when stretched or compressed by an outside force, such as might be caused by underlying transformable airfoil frame structures, as discussed more fully below. In the present embodiment, nickel titanium enables repeated recoverable plastic strain deformation and repeated recoverable plastic shear deformation with little or no reduction in skin durability. However, in an alternative embodiment, the material may be selected to enable elastic deformation, such that the springs 12 will provide a contraction force in accordance with Hook's Law when extended.

An alternative skin may employ plastically deformable springs but remain elastic depending on the material chosen to coat the springs 12 and connecting beams 14. For example, an accompanying elastomeric material, such as rubber may provide sufficient elasticity to cause the plastically deformable springs 12 to return to their original position, thereby causing the entire skin 10 to behave elastically.

The flexible transformable skin 10 may undergo relatively large in-plane deformation while maintaining predetermined ratios (or other relationships, such as nonlinear functions) between horizontal strain, vertical strain, and in-plane shear deformation. Longitudinal strain is a measure of extension or contraction of a material line in a given direction. Shear strain is measure of change in angle between two orthogonal (at 90 degrees to each other) material lines.

FIG. 2 is a diagram of the flexible skin 10 of FIG. 1 in a partially extended position. When the springs 12 extend, the radii of curvature of the springs 12 increase, or the curvature of the springs 12 change from smooth curves to more triangular curves. The changes in shapes of the curves and/or the changes in the radii of curvatures of the curves of the springs 12 enable the beams 14 to separate further without yielding vertical strain deformation. Specifically, the shape changes of the curves of the springs 12 from rounded to more triangular or V-shaped enable the skin 10 to exhibit horizontal strain deformation in-line with the longitudinal axis 16 while exhibiting no vertical strain deformation.

The skin 10 may slightly compress vertically, thereby exhibiting vertical strain deformation, when the skin 10 stretches horizontally beyond a predetermined point. This point may be tailored by adjusting the initial shapes of the curves of the springs 12. For the purposes of the present discussion, the vertical compression is considered vertical strain deformation, which may be elastic or plastic deformation (including recoverable plastic deformation) or a combination thereof depending on the application.

In the present specific embodiment, any vertical strain deformation is minimal compared to the accompanying horizontal strain deformation resulting from stretching of the springs 12. However, the amount of compression resulting from horizontal extension of the skin 10 may be adjusted by adjusting the diameter and radii of curvature of the curves of the springs 12.

Those skilled in the art will appreciate that the rate of change in diameters of the springs 12 with respect to the radii of curvature of the springs 12 (Δ diameter/Δ radii of curvature) is a function of the radii of curvature of the springs. Smaller radii of curvatures result in smaller rates of change in spring diameter. Accordingly, a highly compressed spring will exhibit less reduction in diameter in response to stretching than a corresponding extended spring. Hence, to minimize compression of the skin 10 in response to horizontal strain deformation, the radii of curvature of the springs 12 are made relatively small, such that the springs 12 are initially highly compressed.

Those skilled in the art will appreciate that the springs 12 may be implemented via other extendible structures, such as pivotally linked rods (not shown). Such linked rods would likely exhibit elastic strain deformation unless coated or otherwise interconnected with an elastomeric material or unless pivot connectors connecting the linked rods were spring loaded.

Changes in spring height with respect to changes in radii of curvature may be understood more fully by observing the rate in change in height (h) of a right triangle with respect to the base (b) of the triangle, which is given by the following equation derived from the Pythagorean Theorem:

$$\frac{ⅆ h}{ⅆ b} = \frac{- b}{\sqrt{{c}^{2} - {b}^{2}}} , \qquad [ 1 ]$$

where c is the hypotenuse of the right triangle and is constant, since the lengths of the traces of the springs 12 remain approximately constant. Note that as b increases, the absolute value of the rate of change in height with respect to the base (dh/db) increases. Hence, assuming a fixed spring trace length (c constant), then as b increases (where b relates to the radii of curvature of the springs 12), h (where h relates to spring diameter) compresses more rapidly with increases in b, since the absolute value of dh/db increases with increases in b.

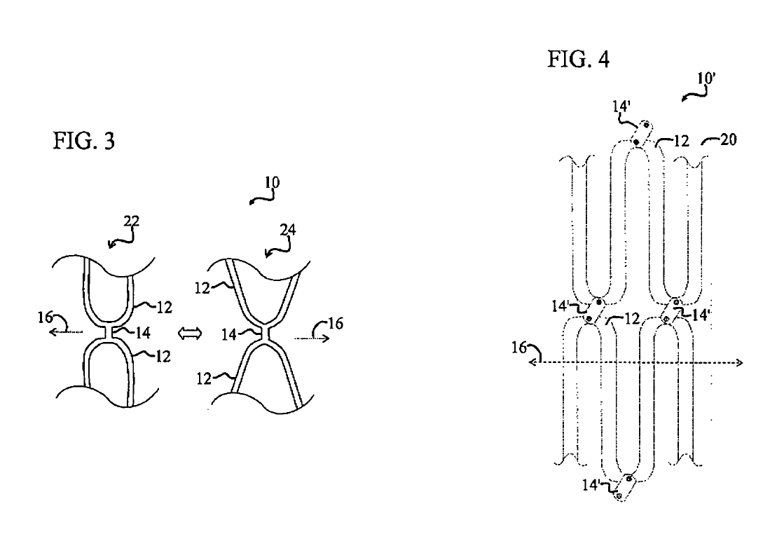

FIG. 3 is a diagram juxtaposing magnified views of a first exemplary junction configuration 22 and a more extended second exemplary junction configuration 24, which may be used with the skins 10 of FIGS. 1 and 2, respectively. In the first junction configuration 22, the springs 12 exhibit relatively tight-radius curves, which are substantially U-shaped. As the spring 12 of the first configuration 22 expands to the second configuration 24, the U-shaped curves transition to substantially V-shaped curves. The natural transition of the curves of the springs 12 from the U-shape to the V-shape enables horizontal strain deformation without corresponding vertical strain deformation. Note that in FIG. 3, the lengths of the illustrated segments of the springs 12 shown are equal in both the first compressed configuration 22 and the second stretched configuration 24. Furthermore, note that the footprint of the first configuration 22 is equal in height but narrower than that of the second configuration 24. Hence, the transitions between the first compressed configuration 22 and the second stretched configuration 24 represent horizontal strain deformation in line with the horizontal axis 16 with no corresponding vertical strain deformation.

Hence, FIG. 3 illustrates that extension along the axis 16 of the substantially planar springs 12 is facilitated by the change in shape of the spring curves, i.e., by the straightening of the bends or curves in the spring segments 12 between connecting beams 14. The vertical connecting beams 14 facilitate this natural transition in response to opposing forces acting along the axis 16. The partially straightened segments bend or rotate outward about the vertical connecting beams 14 to facilitate in-plane horizontal strain with little or no vertical strain.

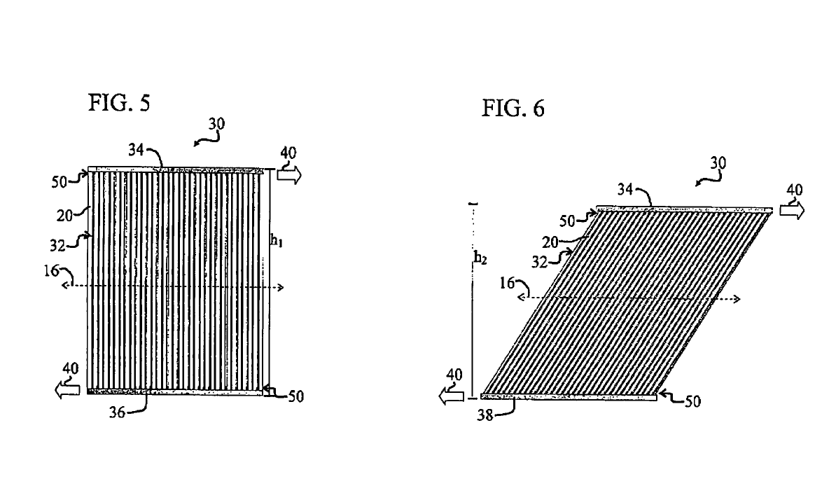

FIG. 4 is a magnified view of a first alternative embodiment 10′ of the flexible skin 10 of FIG. 1. The alternative skin 10′ of FIG. 4 is similar to the skin 10 of FIG. 1 with the exception that the connecting beams 14 shown in FIG. 1 are replaced with pivoting connecting structures 14′ in FIG. 4. Furthermore, the flexible skin 10′ includes an elastomeric skin coating 20 that coats the springs 12 and accompanying pivoting connecting structures 14′. Unlike the skin 10 of FIG. 1, the skin 10′ facilitates horizontal shear deformation when the springs 12 remain maximally compressed.

The pivoting connecting structures 14′ are pivotally connected between adjacent springs 12. These pivoting connecting structures 14′ facilitate horizontal shear deformation. The pivot connectors that connect the pivoting connecting structures 14′ to the partially-planar springs 12 may be readily constructed by those skilled in the art via well-known MicroElectroMechanical Systems (MEMS) processes.

The connecting structures 14′ enable horizontal shear deformation but limit vertical strain deformation beyond that which occurs in response to horizontal shear deformation. Hence, when the connecting structures 14′ are oriented vertically and the springs 12 are maximally compressed, further vertical expansion is inhibited. Furthermore, no vertical strain deformation due to skin contraction is enabled without corresponding shear deformation or horizontal strain deformation.

The pivoting connecting structures 14′ may be replaced with various other types of connecting structures without departing from the scope of the present invention. For example, rather than including pivot connectors at each end of the connecting structures 14′, the connecting structures 14′ may be rigidly connected to the springs 12 at each end with pivot connectors in the middles of the connecting structures 14′.

The skin 10′, with the accompanying elastomeric coating 20, is a highly flexible super-elastic skin that can undergo several-fold stretching and shear (angular) deformation repeatedly with insignificant non-recoverable permanent deformation. The memory material comprising the springs 12 facilitates several-fold stretching and shear deformation in response to austenite to martensite phase transformation. Various application-specific skin parameters, such as spring dimensions and skin thickness, are chosen so that skin 10′ does not exceed maximum allowable strain.

In the present specific embodiment, the skin 10′ is a super-elastic skin that can exhibit large in-plane elastic deformation when subjected to small in-plane forces, which is partly due to the austenite to martensite phase transformation of nickel titanium. The recoverable strains can exceed eight percent. Nickel titanium is austenite in phase throughout the operating temperature range when not subjected to loading that causes phase change. Those skilled in the art will appreciate that various materials other than nickel titanium may be employed without departing from the scope of the present invention.

FIG. 5 is a diagram of an alternative embodiment 30 of the flexible skin of FIG. 1. The alternative flexible skin 30 lacks springs but includes vertical nickel titanium rods or connecting beams 32 that are pivotally connected in parallel between a top horizontal beam 34 and a bottom horizontal beam 36. The vertical connecting beams 32 are pivotally connected to the horizontal beams 34, 36 via flexible connectors 50, as discussed more fully below. Alternatively, the vertical connecting beams 32 may be pivotally connected to the horizontal beams 34, 36 via other pivoting connectors, such as MEMS pivot connectors similar to the connecting beams 14′ of FIG. 4.

The vertical connecting beams 32 and accompanying horizontal beams 34, 36 are covered with the elastomeric polymer 20 coating, which may include one or more layers. In the present embodiment, the elastomeric polymer coating 20 is made from rubber, however other materials may be employed without departing from the scope of the present invention.

FIG. 6 is a diagram of the flexible skin of FIG. 5 exhibiting shear deformation. With reference to FIGS. 5 and 6, in operation, horizontal shearing forces 40 applied to the skin 30 cause the skin 30 to exhibit shear deformation as shown in FIG. 6. When the skin 30 exhibits shear deformation, the height of the skin shrinks from h₁ (see FIG. 5) to h₂ (see FIG. 6). The rigidity of the connecting beams 32 prevents extension of the height of the skin 30 beyond h₁. The maximum reduction in height of the skin 30 in response to shear deformation is partly a function of the spacing between the connecting beams 32. Larger spaces between connecting beams 32 relative to the widths of the connecting beams 32 enable more drastic shearing and corresponding vertical compression. The elasticity of the skin 30 is provided via the elastomeric coating 20.

Hence, the skin 30 behaves similarly to the skin 10′ of FIG. 4 in that both skins 10′, 30 facilitate or enable horizontal shear deformation, which results in a corresponding vertical strain deformation (compression). Furthermore, both skins 10′ 30 inhibit vertical strain deformation beyond a certain height, which is h₁, for the skin of FIG. 5. Furthermore, both skins 10′, 30 inhibit bending deformation partially due to rigidity of the connecting beams 14′, 32 of FIGS. 4 and 5, respectively.

The skin 30 of FIGS. 5 and 6 inhibits in-plane bending deformation, such as deformation about the horizontal skin axis 16. The skin 30 also inhibits bending deformation about any axis, such as the horizontal axis 16, contained within the plane of the skin 30. For example, the rigid connecting beams 34, 36 prevent bending deformation about an axis (not shown) perpendicular to the horizontal axis 16 and prevent bending deformation about an axis parallel to the horizontal axis 16. For the purposes of the present discussion, the term the plane of the skin 30 is used synonymously with the space, including skin area and volume, occupied by the skin 30 itself.

Unlike the skin 10′ of FIG. 4, the skins of FIGS. 5 and 6 inhibit horizontal strain deformation. Alternatively, the skin 30 may enable horizontal deformation in applications wherein the rigid horizontal beams 34, 36 are omitted or replaced with elastomeric beams that can stretch horizontally.

Plural skin sections 30 may be stacked upon each other, cascaded, or arranged in other patterns to achieve overall desired skin-structure, shapes, and performance characteristics. For example, the top horizontal beam 34 may act as the bottom horizontal beam for another skin section (not shown).

Geometric patterns formed by the springs 12 of FIGS. 1-4 or the beams 32-36 of FIGS. 5 and 6 may adjusted to meet the needs of a given application. The exact skin pattern is application specific and depends on shape-change and loading requirements of a particular application. Energy required to produce several-fold deformation is often minimized in patterns that undergo only rigid body motion.

Skin bending stiffness, i.e., in-plane rigidity may be adjusted by selectively varying the thickness of the reinforcement pattern, such as the springs 12 of FIGS. 1-4. When thickness is limited by manufacturing restrictions, skin layering may be employed to achieve the desired bending stiffness.

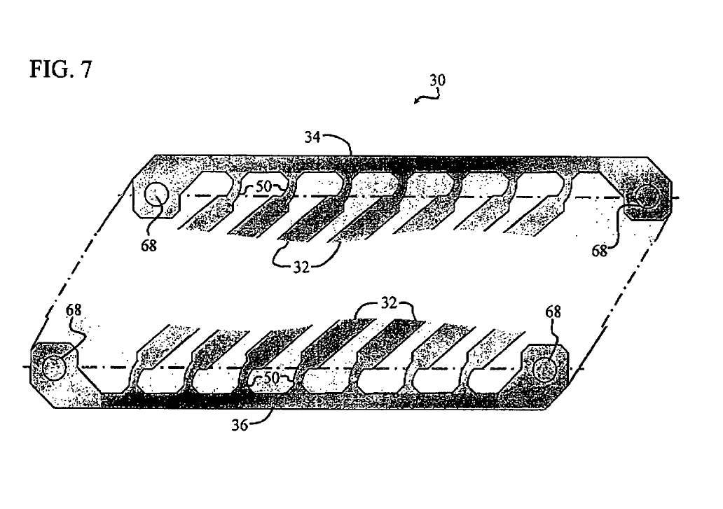

FIG. 7 is a magnified view illustrating the flexible connectors 50 between connecting beams and the bottom horizontal beam 38 of the flexible skin 30 of FIG. 6 in bent, i.e. pivoted or rotated configurations. In the present specific embodiment, the flexible connectors 50 are implemented via constrictions in the vertical connecting beams 50. The connecting beams 32 are glued to the rigid horizontal connecting beams 34, 36 via a desired adhesive at bases of the flexible connectors 50. Alternatively, the connecting beams 32 and the flexible connectors 50 are integral with the horizontal connecting beams 34, 36.

The constrictions that comprise the flexible connectors 50 are sufficiently narrower than the vertical connecting beams 32 to facilitate pivoting or bending. With reference to FIGS. 5, 6, and 7, the bending of the thinner flexible connectors 50 enable in-plane rotation or pivoting, thereby enabling angular changes between the connecting beams 32 and the rigid horizontal connecting beams 34, 36.

Alternatively, the flexible connectors 50 may be constructed from a different, more flexible material than the vertical connecting beams 32. This case would not require that the flexible connectors 50 be narrower than their corresponding connecting beams 32.

In the magnified view of the skin 30 of FIG. 7, various attachment holes 68 are shown at the ends of the horizontal connecting beams 34, 36. These attachment holes 68 facilitate attaching the skin 30 to a desired substrate, such as a transformable wing frame.

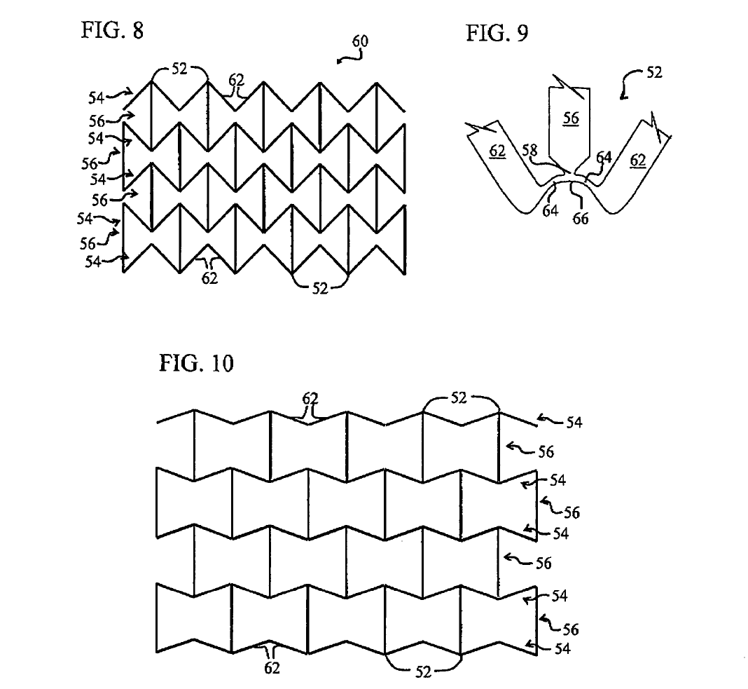

FIG. 8 is a diagram of a third alternative embodiment 60 of the flexible skin 10 of FIG. 1 having unique elastically hinged junctions 52 for tailoring horizontal and vertical strain deformation characteristics. The alternative flexible skin 60 include horizontal zigzag beams 54 comprising linked angled legs 62, which are linked at the unique junctions 52. The zigzag beams 54 may be viewed as juxtaposed V-formations having a series of vertices that are connected to opposing vertices of adjacent zigzag beams 54 via relatively rigid vertical legs 56. The vertical legs 56 are pivotally connected to the vertices of the zigzag beams 54 at the unique junctions 52.

FIG. 9 is a more detailed diagram illustrating one of the unique junctions of FIG. 8. With reference to FIGS. 8 and 9, in the present specific embodiment, the angled legs 62 and the interconnecting vertical legs 56 are sufficiently rigid to provide in-plane rigidity suitable for a given application. The vertical legs 56 are pivotally connected at the unique junctions 52 via vertical-leg constricted sections 58. Similarly, the angled legs 62 are pivotally connected at the unique junctions 52 via angled-leg constricted sections 64. The various constricted sections 64, 58 are sufficiently thick to provide in-plane rigidity and sufficiently narrow to enable pivoting of the vertical legs 56 to meet the needs of a given application.

Those skilled in the art may tailor the dimensions of the constricted sections 64, 58 to provide a desired resistance to pivoting, thereby tailoring the degree to which the skin 60 resists shearing stress and associated shear deformation. Furthermore, the dimensions of the contoured shapes of the constricted sections 64 of the unique junctions 52 may be tailored to provide a desired ratio between horizontal strain and vertical strain.

For example, as the angled-leg sections 62 move outward in response to horizontal strain, the junctions 52 push on the vertical legs 56, thereby causing vertical displacement, i.e., strain in the vertical direction. However, by adjusting the shape of the junctions 52, the amount of vertical displacement of the legs 56, and therefore, the amount of vertical strain resulting for a given horizontal strain may be adjusted accordingly. For example, by making bottom inverted-U formations 66 formed at the junction between angled legs 62 and the vertical legs 56 taller or shorter, the amount of vertical displacement of the vertical legs 56 in response to pivoting of the angled-legs 62 may decrease or increase, respectively. Hence, the vertical strain experienced in response to a given horizontal strain may be adjusted accordingly, such as by adjusting the aspect ratio of the inverted-U formations 66, to achieve a desired ratio or relationship between strain deformation in perpendicular planar directions. One skilled in the art with access to the present teachings may tailor the relative deformation of the flexible skin 60 in perpendicular planar directions to meet the needs of a given application without undue experimentation.

The load-bearing capacity of the flexible skin 60 may be further increased by layering the flexible skin 60 with various elastomeric polymer layers. The numbers of reinforcement layers depend on the required bending stiffness.

FIG. 10 is a diagram of the flexible skin 60 of FIG. 8 in a partially extended position. The flexible skin 60 of FIG. 10 is stretched to approximately twice the horizontal length of the corresponding flexible skin 60 of FIG. 8. The skin 60 of FIG. 8 is vertically stretched approximately 1.25 times the height of the flexible skin 60 of FIG. 8. Hence, the relationship between the horizontal and vertical strain exhibited by the skin 60 is not 1-to-1 in the present embodiment. However this relationship may be readily tailored by adjusting the dimensions and shapes of the unique junctions 52. The relationship between the vertical strain and horizontal strain exhibited by the skin 60 may be linear or nonlinear functions depending on the exact geometry of the junctions 52.

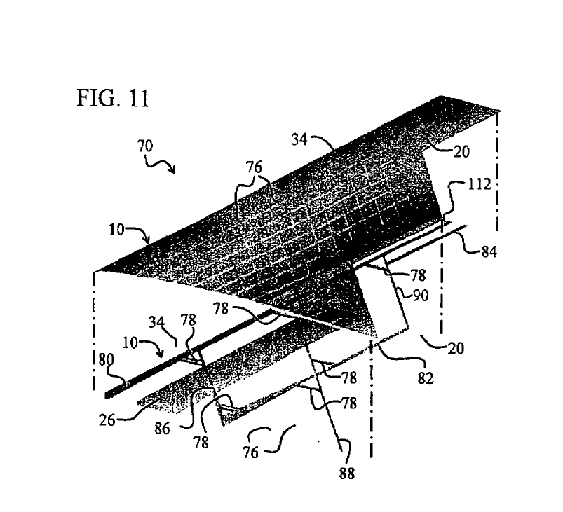

FIG. 11 is a diagram of an exemplary morphing airfoil 70 employing the flexible skin 10 of FIG. 1. The airfoil 70 includes the flexible skin 10, which is coated with the elastomeric material 20. In the present embodiment, the airfoil 70 includes various adjustable spars 80, 82, 84, including a leading spar 80, a trailing spar 82, and a wingtip spar 84. Various adjustable ribs 86, 88, 90, including a first rib 86, a second rib 88, and a third rib 90 are pivotally interconnected to the spars 80, 82, 84. The adjustable ribs 86, 88, 90, and spars 80, 82, 84 form an adjustable frame that is sandwiched by the flexible skin 10, which is reinforced with crisscrossed stiffening rods 76 that provide further in-plane rigidity.

The adjustable ribs 86, 88, 90, and spars 80, 82, 84 are interconnected so that expansion or contraction of the base chord of the airfoil 70 automatically sweeps a leading edge 34 backward or forward. The rigid stiffening rods 76, which may be implemented via substantially flat beams, may pivot relative to each other to facilitate shear deformation. This pivoting functionality may be enabled via pivot connectors (not shown) between the crisscrossed stiffening rods 76. Alternatively, the crisscrossed stiffening rods 76 are not interconnected by pivot connectors, but instead, are held in place via an elastomeric polymer 20 disposed over the rods 76.

Deformation-control structures 26, which include partially flattened (elliptical) bellows structures 26, permit airfoil frame morphing but resist airfoil twisting. Various actuators 78 interconnect the ribs 86, 88, 90 and spars 80, 82, 84 and facilitate airfoil morphing, such as sweep-angle, area, wing span, and base chord length adjustments.

In the present embodiment, the flexible skin 10 is chosen to accommodate shear deformation and resist or partially resist biaxial or twisting deformation. The shear deformation of the airfoil 14 may minimize energy required to flex the skin 10, thereby reducing requisite sizes, strengths, and associated costs of the actuators 78.

The actuators 78 are chosen so that if they fail, they may telescope relatively free of resistance. Accordingly, if one of the actuators 78 fail, the airfoil 70 will not be frozen or locked in to position. Such actuators are well known and commercially available.

In the present specific embodiment, the skin 10′ requires minimal energy to implement large skin strain and/or shear deformation. The thickness of the skin 10 is selectively adjusted across the surface are of the airfoil 70 to provide desired properties in certain areas of the airfoil. For example, regions of the airfoil 70 requiring enhanced rigidity, such as near the center of pressure (not shown) of the airfoil 70, may be fitted with thicker transformable skin 10 or multiple layers of transformable skin 10.

Thus, the present invention has been described herein with reference to a particular embodiment for a particular application. Those having ordinary skill in the art and access to the present teachings will recognize additional modifications, applications, and embodiments within the scope thereof.

It is therefore intended by the appended claims to cover any and all such applications, modifications and embodiments within the scope of the present invention.

Accordingly,

1. A transformable skin comprising:
first means for enabling a first type of deformation of said skin and
second means for resisting a second type of deformation different than said first type of deformation in direction or form.

2. The skin of claim 1 wherein said first means and said second means are interconnected.

3. The skin of claim 2 wherein said first type of deformation is strain deformation along a first path, said first path inline with a first axis contained within an area of said skin.

4. The skin of claim 3 wherein said second type of deformation includes shear deformation.

5. The skin of claim 3 wherein said second type of deformation includes strain deformation inline with a second axis angled relative to said first axis.

6. The skin of claim 5 wherein said first axis is approximately perpendicular to said second axis.

7. The skin of claim 6 wherein said first mechanism includes plural partially planar spring structures arranged parallel to each other.

8. The skin of claim 7 wherein said spring structures are manufactured from a memory material and exhibit recoverable plastic deformation.

9. The skin of claim 8 wherein said memory material is nickel titanium.

10. The skin of claim 8 wherein said partially planar spring structures are resistant to bulging or bending from an initial plane of said skin and further including means for selectively varying resistance to bending or bulging in different regions of said skin.

11. The skin of claim 7 wherein said plural partially planar spring structures are interconnected via connecting structures included in said second means, said connecting structures resistant to bending.

12. The skin of claim 11 wherein said plural partially planar spring structures arc covered with an elastomeric material

13. The skin of claim 12 wherein said connecting structures arc rigid.

14. The skin of claim 12 wherein said connecting structures include pivot connectors.

15. The skin of claim 1 wherein said first type of deformation includes shear deformation.

16. The skin of claim 15 wherein said first type or deformation further includes strain deformation up to a predetermined length.

17. The skin of claim 16 wherein said second type of deformation includes strain deformation beyond said predetermined length.

18. The skin of claim 17 wherein said skin includes plural parallel stiff members, said parallel stiff members being resistant to bending and interconnected via an elastomeric material.

19. A transformable skin comprising:
first means for providing in-plane rigidity of said skin and
second means for enabling deformation within a plane of said skin, said second means employing said first means.

20. The skin of claim 19 wherein said second means includes means for employing said first means to enable shear and/or strain deformation of said skin.

21. A transformable skin comprising:
first means for enabling deformation in a first direction approximately inline with a first axis of said skin and
second means for resisting deformation in a second direction and about said first axis.

22. The skin of claim 21 wherein said first direction is confined within a surface area of said transformable skin.

23. The skin of claim 22 wherein said second direction is approximately perpendicular to said first direction.

24. The skin of claim 23 wherein said first means includes plural partially planar springs that resist bending, which corresponds to deformation about said first axis, but enable stretching along said first axis, which includes said deformation in said first direction.

25. The skin of claim 24 wherein said second means includes connectors between said plural partially planar springs, said connectors being resistant to bending.

26. The skin of claim 25 wherein said connectors are resistant to extending.

27. The skin of claim 24 wherein said second means includes pivot connectors between said plural partially planar springs, said pivot connectors being resistant to bending, but enabling shear deformation of said transformable skin.

28. A transformable skin comprising:
first means for enabling shear or strain deformation along a first path coincident with a first axis or said skin;
second means for resisting bending deformation about said first axis; and
third means for resisting stain deformation along a second path beyond a predetermined distance, said second path approximately perpendicular to said first path.

29. The skin of claim 28 wherein said transformable skin includes interconnected nickel titanium spring structures.

30. The skin of claim 28 wherein said transformable skin includes one or more support beams or stiffening rods.

31. The skin of claim 30 wherein said one or more support beams or stiffening rods may pivot relative to one or more additional support beams or rods oriented in different directions than said one or more support beams or stiffening rods.

32. The skin of claim 28 wherein said transformable skin further includes a deformable wing upon which said skin is mounted, said deformable wing configured so that changes in sweep result in corresponding changes in wing chord.

33. The skin of claim 32 wherein said transformable wing further includes bellows structures to inhibit airfoil twisting.

34. The skin of claim 33 wherein said transformable skin is fitted with crisscrossed reinforcement to further enhance in-plane rigidity.

35. The skin of claim 34 wherein said skin exhibits selectively varying thickness.

36. A deformable skin comprising:
first means for enabling shear or strain deformation along a first direction;
second means for resisting bending deformation about a plane of said deformable skin, thereby causing said skin to exhibit in-plane rigidity; and
third means for controlling strain deformation along a second direction as a function of said strain deformation along said first direction.

37. The skin of claim 36 wherein said third means includes junctions that facilitate establishing a predetermined relationship between horizontal strain and vertical strain, said predetermined relationship determined by geometry of said elastically hinged junctions.

38. The skin of claim 37 wherein said predetermined relationship is such that said skin exhibits approximately no vertical strain deformation in response to certain strain deformation.

39. The skin of claim 38 wherein said junctions include vertical connecting beams extending between substantially U-shaped curves or V-shaped curves, said U-shaped curves transitioning to substantially V-shaped curves or vice versa in response to said certain horizontal strain, thereby not resulting in corresponding vertical strain.

40. The skin of claim 37 wherein said junctions ate elastically hinged junctions.

41. The skin of claim 40 wherein each or said elastically hinged junctions include constrictions between angled legs and a vertical leg, said constrictions meeting at a vertex of each of said elastically hinged junctions.

42. The skin of claim 41 wherein said angled legs and said vertical leg are substantially rigid.

43. The skin of claim 42 wherein two or more of said elastically hinged junctions are interconnected so that said vertical leg of each of said two or more elastically hinged junctions is connected to another elastically hinged junction at said vertex thereof.

44. The skin of claim 43 further including an inverted-U formation formed at said junction, an aspect ratio of said inverted-U formation affecting said predetermined relationship between horizontal strain and vertical strain.
